(19) United States
(12) Patent Application Publication
(10) Pub. No.: US 2007/0099003 A1
(43) Pub. Date: May 3, 2007

(54) Titanate-containing material and method for making the same

(76) Inventors: Ming-Kwei Lee, Kaohsiung City (TW); Chung-Min Shih, Tainan City (TW); Tsung-Hsiang Shih, Lo-Tung Chen (TW)

Correspondence Address: CHRISTIE, PARKER & HALE, LLP, PO BOX 7068, PASADENA, CA, 91109-7068, US

(21) Appl. No.: 11/389,599

(22) Filed: Mar. 24, 2006

(30) Foreign Application Priority Data
Oct. 21, 2005 (TW) 094136873

(51) Int. Cl. B05D 1/40; B05D 3/02; B05D 1/18; B32B 13/04; B32B 19/00

(52) U.S. Cl. 428/446; 427/430.1; 427/331; 427/372.2; 428/696; 428/702

(57) ABSTRACT

A titanate-containing material includes: a silicon-containing layer; and a crystalline layer of ammonium oxotrifluorotitanate formed on the silicon-containing layer. A method for making a titanate-containing material includes: immersing a silicon-containing substrate into an aqueous solution containing hexafluorotitanate radicals; and reacting the hexafluorotitanate radicals with water so as to form a crystalline layer of an oxotrifluorotitanate compound on the silicon-containing substrate.

### CROSS-REFERENCE TO RELATED APPLICATION

This application claims priority of Taiwanese application no. 094136873 filed on Oct. 21, 2005.

### BACKGROUND OF THE INVENTION

1. Field of the Invention

This invention relates to a titanate-containing material and a method for making the same.

2. Description of the Related Art

Photocatalyst is a material having a catalytic function when irradiated by ultraviolet light or sunlight. That is, when exposed to UV light or sunlight, photocatalysts become active in decomposing pollutants or other organic matters to be treated.

Titanium dioxide is a commercially available photocatalyst. Since it is an inorganic compound with high safety and less damage to the environment, titanium dioxide is widely used in air cleaners, air conditioners, medical devices, buildings, and UV protecting devices, thereby realizing antibiotic, antifouling, air-cleaning, and deodorizing functions.

Titanium dioxide particles are usually prepared by sol-gel process or calcination of crystalline precursors thereof. Sol-gel process is conducted by reacting titanate alkylester, such as titanium ethoxide or titanium isopropoxide, with water to form a sol having microparticles of metal oxide, and subsequently by gelling the microparticles to form an insoluble gel so as to obtain particulate titanium dioxide. The calcining process is conducted by calcining a crystalline precursor of titanium dioxide, such as NH₄TiO₃, (NH₄)₃TiO₅, (NH₄)₂TiO₄, NH₄TiO_{0.4}F_{4.2}, (NH₄)_{0.3}TiOF₂, (NH₄)_{0.9}TiO_{0.4}F_{4.1}, (NH₄)_{0.8}TiOF_{2.8} and (NH₄)_{0.3}TiO_{1.1}F_{2.1}, so as to produce particulate titanium dioxide.

In use, especially for photocatalyst applications, titanium dioxide is usually supported on a surface of a substrate. Therefore, a substrate having titanium dioxide deposited thereon has been proposed (see Y. Teraoka, “Chem. Commum.”, 2001, pp 1344-1345) so as to avoid the steps of precipitation, filtration, centrifugation, and deposition of titanium dioxide.

In the literature published by Y. Teraoka, a method for preparing crystalline particles of ammonium oxotrifluorotitanate (NH₄TiOF₃) on an organic substrate is disclosed. In this method, an air/water monolayer of dioctadecyldimethylammonium bromide (DODMABr) serving as a carrier is formed on a surface of a solution of boric acid (H₃BO₃) and ammonium hexafluorotitanate ((NH₄)₂TiF₆). The molar ratio (B/Ti) of boric acid to ammonium hexafluorotitanate in the solution is not less than 1 and smaller than 1.5 (1≦B/Ti<1.5). After reacting for a period of time, crystalline NH₄TiOF₃ is formed on a hydrophilic surface (the surface of the solution, crystal-growth side), and Br is evaporated such that a DODMA film with NH₄TiOF₃ deposited thereon is obtained. NH₄TiOF₃ deposited on DODMA film is converted into anatase titanium dioxide by air-calcination at 873 degree Kelvine for 1 hour.

The disadvantages of such method reside in that the ratio (B/Ti) of the reactants should be strictly controlled to be within the range of 1 (included) to 1.5 (not included), high proportion of NH₄TiOF₃ crystalline particles is precipitated, and a part of the organic DODMA film is decomposed during air-calcination. In addition, since the DODMA film is relatively thin (<0.5 μm), the film has a tendency to deform.

### SUMMARY OF THE INVENTION

Therefore, the object of the present invention is to provide a titanate-containing material and a method for making the same that can overcome at least one of the aforesaid drawbacks associated with the prior art.

According to one aspect of this invention, a titanate-containing material comprises: a silicon-containing layer; and a crystalline layer of ammonium oxotrifluorotitanate formed on the silicon-containing layer.

According to another aspect of this invention, a method for making a titanate-containing material, comprises: immersing a silicon-containing substrate into an aqueous solution containing hexafluorotitanate radicals; and reacting the hexafluorotitanate radicals with water so as to form a crystalline layer of an oxotrifluorotitanate compound on the silicon-containing substrate.

According to yet another aspect of this invention, a method for producing titanate dioxide particles comprises the steps of: forming a hexafluorotitanate compound on a silicon-containing substrate; and calcining the hexafluorotitanate compound on the silicon-containing substrate.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a side view of the first preferred embodiment of an ammonium oxotrifluorotitanate-containing material according to this invention observed by Field Emission Scanning Electron Microscope (FESEM);

FIG. 2 is a photograph showing the structure of a grain of the crystalline layer of the ammonium oxotrifluorotitanate-containing material of the first preferred embodiment observed by FESEM;

FIG. 3 is a X-ray Diffraction (XRD) pattern illustrating the crystalline characteristics of the ammonium oxotrifluorotitanate-containing material of the first preferred embodiment;

FIG. 4 is a photograph showing the structure of a grain of the crystalline layer of the ammonium oxotrifluorotitanate-containing material of the first preferred embodiment observed by high resolution transmittance electron microscope (HRTEM) in the direction [001] of the electron beams;

FIG. 5 is a photograph showing the structure of the grain of the crystalline layer of the ammonium oxotrifluorotitanate-containing material of the first preferred embodiment observed by high resolution transmittance electron microscope (HRTEM) in the direction [010] of the electron beams;

FIG. 6 is a photograph showing the surface status of the grain of the crystalline layer of the ammonium oxotrifluorotitanate-containing material of the first preferred embodiment observed by backscattered electron image (BEI) device;

FIG. 7 is a plot showing transmittance of the crystalline layer of the ammonium oxotrifluorotitanate-containing material in the first preferred embodiment and transmittance of the crystalline layer on a substrate of the comparative example 1;

FIG. 8 is a plot showing photon energy of the crystalline layer of the ammonium oxotrifluorotitanate-containing material in the first preferred embodiment;

FIG. 9 is a photograph showing the structure of the grain of the crystalline layer of the ammonium oxotrifluorotitanate-containing material of the second preferred embodiment observed by FESEM;

FIG. 10 is a photograph showing the structure of the grain of the crystalline layer of the ammonium oxotrifluorotitanate-containing material of the third preferred embodiment observed by FESEM;

FIG. 11 is a photograph showing the structure of the grain of the crystalline layer of the ammonium oxotrifluorotitanate-containing material of the fourth preferred embodiment observed by FESEM;

FIG. 12 is a photograph showing the structure of the grain of the crystalline layer of the ammonium oxotrifluorotitanate-containing material of the fifth preferred embodiment observed by FESEM; and

FIG. 13 is a photograph showing the structure of the crystalline layer on a substrate of the comparative example 1 observed by FESEM.

### DETAILED DESCRIPTION OF THE PREFERRED EMBODIMENTS

The preferred embodiment of a titanate-containing material of this invention includes: a silicon-containing layer; and a crystalline layer of ammonium oxotrifluorotitanate formed on the silicon-containing layer.

According to the literature published by Y. Teraoka, hydrofluoride (HF) side product is produced during the reaction. If the HF side product is consumed during the reaction, the ammonium oxotrifluorotitanate will be produced at a higher rate based on the Le Chatelier-Braun's law. Therefore, a silicon-containing material is used in this invention as a carrier for supporting the crystalline layer of ammonium oxotrifluorotitanate thus formed, and is used to react with HF, thereby resulting in an increase in the production rate. Moreover, the applicant surprisingly found that the reaction of silicon-containing layer and HF results in formation of dangling bonds on the surface of the silicon-containing layer. The dangling bonds can enhance bonding and growth of ammonium oxotrifluorotitanate on the silicon-containing layer.

Preferably, the silicon-containing layer is made from a material selected from the group consisting of: polysilicon, Si₃N₄, SiO₂, and combinations thereof. For example, it can be a glass or crystalline substrate. The silicon-containing layer preferably has a thickness greater than 1 μm and can be maintained at a stable state, i.e., anon-deforming state, so as to facilitate subsequent application. The shape of the silicon-containing layer is not limited, and can be, for example, in the form of a plate or a sheet. In a preferred embodiment of this invention, the silicon-containing layer is in the form of a glass plate.

The thickness of the crystalline layer and the granular size of the crystal can be varied based on actual requirements, and are controlled by adjusting the concentration of the reactants, reaction time, or other relevant operating factors. Preferably, the crystalline layer has a thickness less than 10 μm, more preferably less than 5 μm, and most preferably less than 3 μm.

The ammonium oxotrifluorotitanate of the crystalline layer of the titanate-containing material according to this invention is a substantially single crystal structure and preferably has an average diameter ranging from 0.5 to 7.5 μm, and more preferably ranging from 0.5 to 5 μm.

The method for making the titanate-containing material includes: immersing a silicon-containing substrate into an aqueous solution containing hexafluorotitanate radicals; and reacting the hexafluorotitanate radicals with water so as to form a crystalline layer of an oxotrifluorotitanate compound on the silicon-containing substrate.

In this invention, the aqueous solution further contains boric acid and ammonium ions. The molar ratio of ammonium hexafluorotitanate to boric acid is preferably greater than 0.1 and less than 1.5, and more preferably is not less than 0.15. In a preferred embodiment of this invention, the hexafluorotitanate radicals are obtained from ammonium hexafluorotitanate, and the crystalline layer of the oxotrifluorotitanate compound on the silicon-containing substrate is a crystalline layer of ammonium oxotrifluorotitanate.

Preferably, the aqueous solution is obtained by dissolving ammonium hexafluorotitanate and a precursor of boric acid in water. The precursor of boric acid is selected from the group consisting of boric acid ester, borate, borax, boric oxide, and boron oxide.

Alternatively, the aqueous solution is obtained by mixing a first solution containing boric acid with a second solution containing ammonium hexafluorotitanate. The first solution is obtained by dissolving 0.1 to 1 mole boric acid in 1000 ml water. The second solution is obtained by dissolving 0.1 to 2 mole ammonium hexafluorotitanate in 1000 ml water.

Preferably, the method further includes a purifying step conducted by washing the titanate-containing material with deionized water, and a step of drying the washed material.

The method further includes a step of air-calcining the oxotrifluorotitanate compound on the silicon-containing substrate at a temperature not less than 300° C., preferably, at a temperature ranging from 300 to 400° C. so as to form titanate dioxide crystalline particles on the silicon-containing substrate.

### EXAMPLE 1

### Preparation of ammonium oxotrifluorotitanate-Containing Material at 0.6 of B/Ti Ratio

A mixture was prepared by mixing 500 ml of a first solution prepared by dissolving 9.27 g (0.15 mole) boric acid powder into water with 500 ml of a second solution prepared by dissolving 100 g (0.5 mole) ammonium hexafluorotitanate into water, and was kept at 40° C. for forming ammonium oxotrifluorotitanate crystals. A glass plate was immersed in the mixture so as to permit the ammonium oxotrifluorotitanate crystals to be deposited thereon. After two hours, the glass plate with a crystalline layer of ammonium oxotrifluorotitanate was taken out from the mixture, followed by washing with deionized water and drying by N₂ gas.

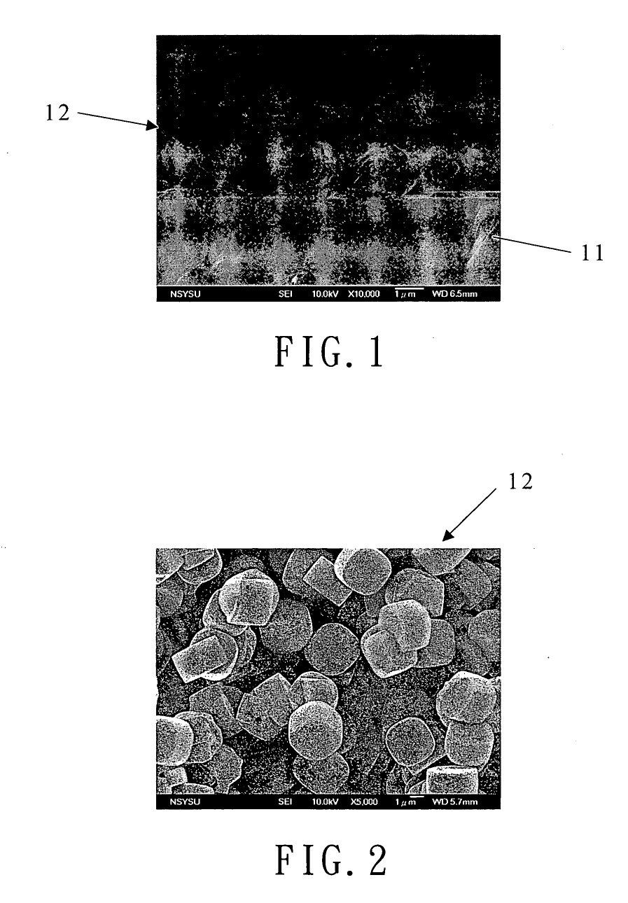

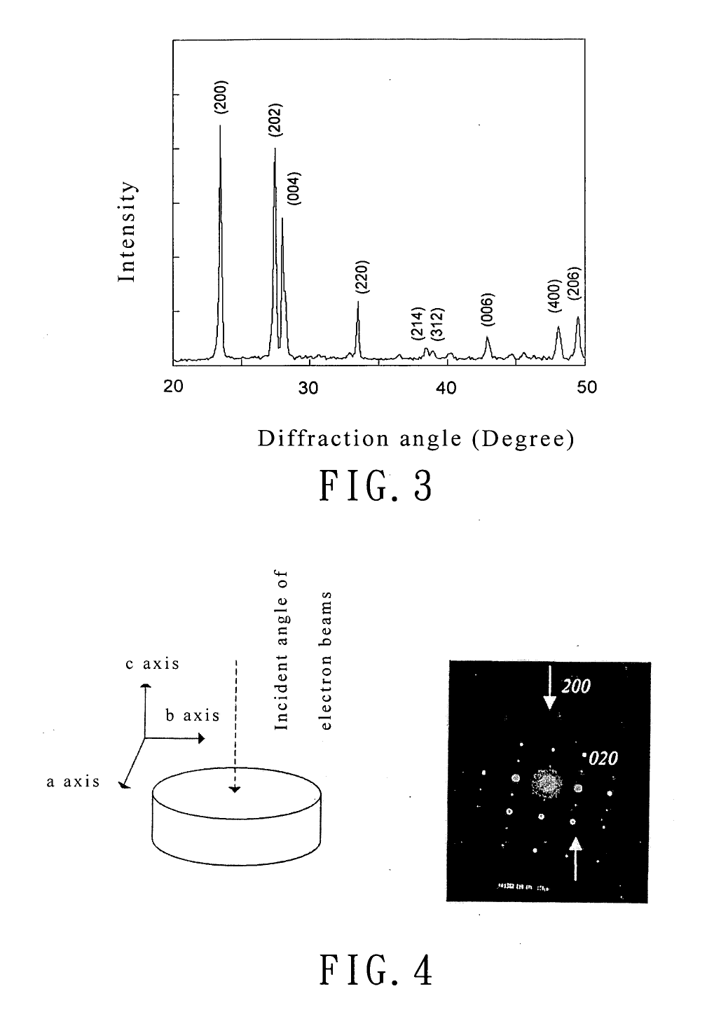

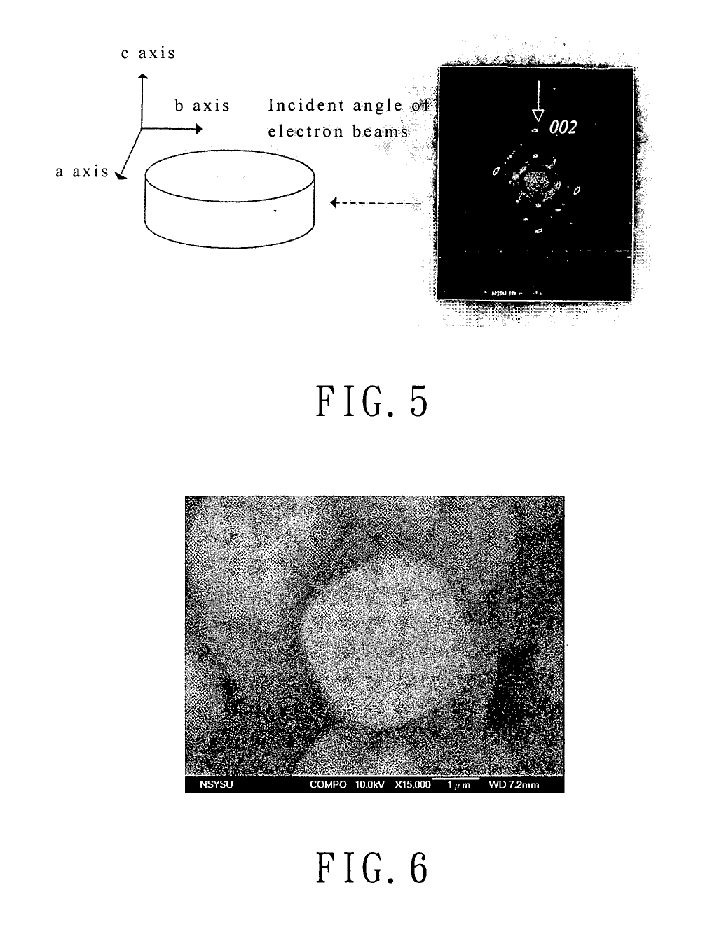

During the washing step, no crystals were detached from the glass plate, which indicates that the crystalline layer has a good adhesion to the glass plate. Moreover, the glass plate with the crystalline layer was observed by Field Emission Scanning Electron Microscopy (FESEM, XL-40FEG, manufactured by Philip). The results are shown in FIGS. 1 and 2. The crystalline layer 12 thus formed on the glass plate 11 has a thickness of 2 μm. X-ray defraction (XRD) test was conducted using X-ray defraction system D5000 manufactured by Siemens Corp. at a condition of 40 kV, 30 mA, 20-50° scanning range (2θ), 1°/min scanning rate, and the copper target λ=0.15406 Å so as to determine the compositions of the crystalline layer 12. FIG. 3 shows that the crystalline layer 12 is ammonium oxotrifluorotitanate, and has an average grain diameter of 2-3 μm. The structure of the crystalline grain 12 was observed using high resolution transmittance electron microscope (HRTEM, 3010 manufactured by JEOL JEM Corp., at 200 kV acceleration voltage) and backscattered electron image system (BEI) XL-40FEG manufactured by Philip Company. The results indicate that the crystalline layer 12 has a very high degree of single crystalline structure, as best shown in FIGS. 4 and 5. Moreover, the color of the crystalline grain 12 shown in FIG. 6 is uniform, which indicates that the compositions of the grains of the crystalline layer 12 are identical.

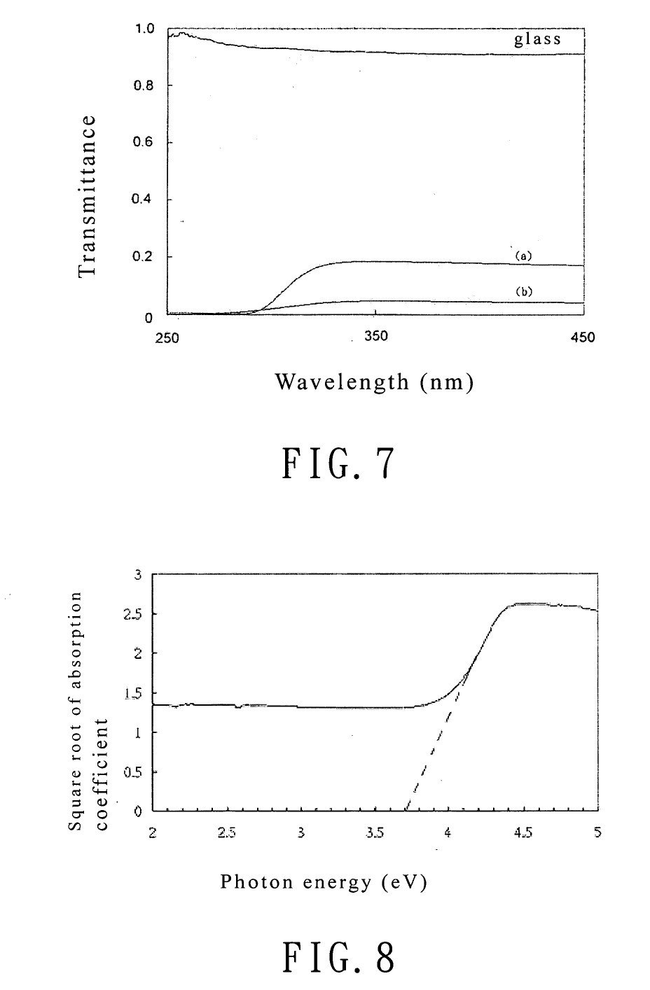

The crystalline layer 12 of ammonium oxotrifluorotitanate was further tested using UV-Vis Spectrometer (DH-2000, manufactured by Mikropack). The results are shown in FIGS. 7 and 8. The curve (a) in FIG. 7 indicates that the transmittance of the ammonium oxotrifluorotitanate crystalline layer at 325-450 nm is 0.2. Moreover, energy band gap of the ammonium oxotrifluorotitanate crystalline layer 12 thus measured is 3.7 eV.

### EXAMPLE 2

Example 2 differs from example 1 in that, after formation of the crystalline layer, the glass plate (first glass plate) together with the crystalline layer was removed from the mixture, and another glass plate (a second glass plate) was immersed into the mixture for another two hours for deposition of ammonium oxotrifluorotitanate crystals thereon.

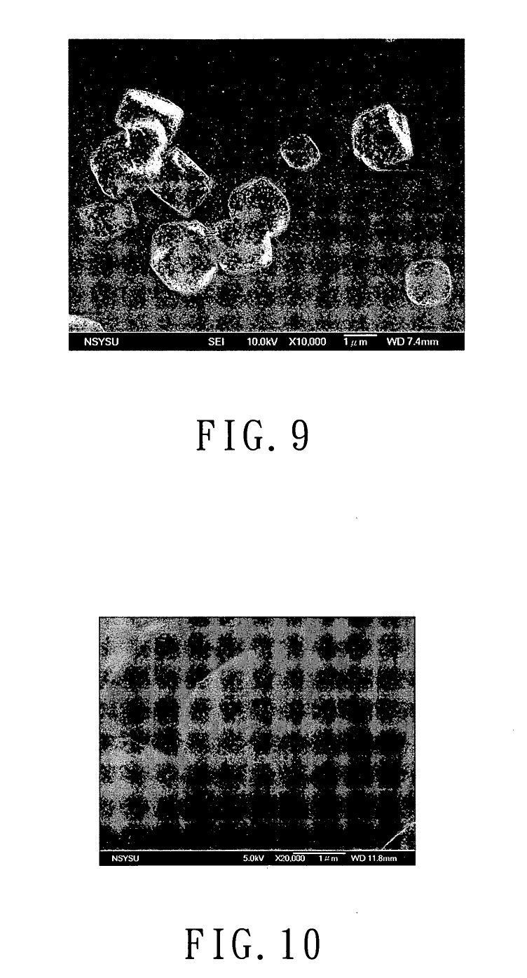

After formation of a crystalline layer of ammonium oxotrifluorotitanate on the second glass plate, the crystalline layer was washed. During the washing step, no crystals were detached from the glass plate, which indicates that the crystalline layer has a good adhesion to the glass plate. As shown in FIG. 9, the morphology and surface smoothness of the crystalline layer on the second glass plate are identical to those of the crystalline layer on the first glass plate. The crystals on the second glass plate have grain sizes smaller than those of the crystals on the first glass plate, and have an average grain diameter around 1 μm.

### EXAMPLE 3

### Preparation of ammonium oxotrifluorotitanate-Containing Material at 0.5 of B/Ti Ratio

Example 3 differs from Example 1 in that the amount of ammonium hexafluorotitanate employed is 60 g (0.3 mole). During the washing step, no crystals were detached from the glass plate, which indicates that the crystalline layer has a good adhesion to the glass plate. As shown in FIG. 10, the crystal observed by FESEM has morphology and smooth surface identical to those in Example 1.

### EXAMPLE 4

### Preparation of ammonium oxotrifluorotitanate-Containing Material at 0.4 of B/Ti Ratio

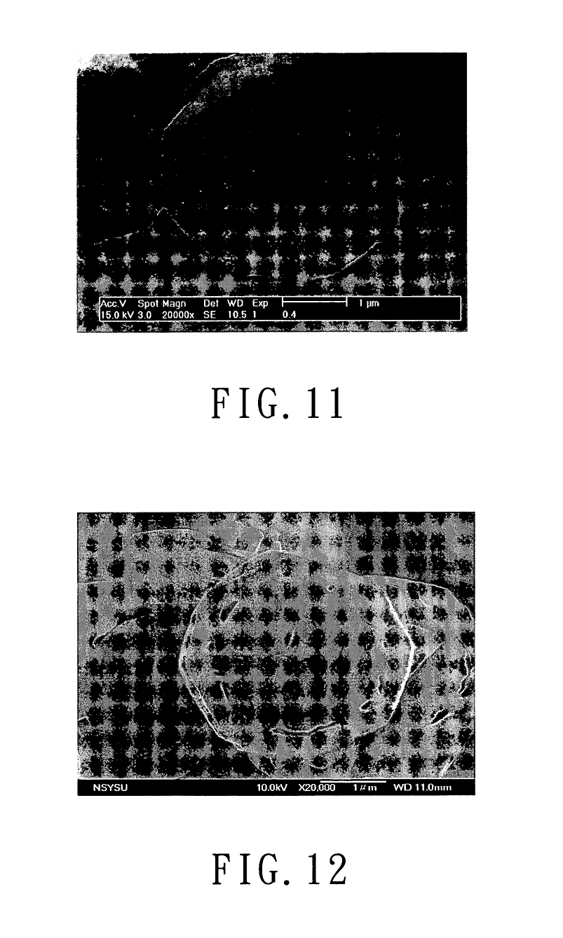

Example 4 differs from Example 1 in that the amount of ammonium hexafluorotitanate employed is 75 g (0.375 mole). During the washing step, no crystals were detached from the glass plate, which indicates that the crystalline layer has a good adhesion to the glass plate. As shown in FIG. 11, the crystal observed by FESEM has morphology and smooth surface identical to those in Example 1.

### EXAMPLE 5

### Preparation of Ammonium oxotrifluorotitanate-Containing Material at 0.2 of B/Ti Ratio

Example 5 differs from Example 1 in that the amount of ammonium hexafluorotitanate employed is 150 g (0.75 mole). During the washing step, no crystals were detached from the glass plate, which indicates that the crystalline layer has a good adhesion to the glass plate. As shown in FIG. 12, the crystal observed by FESEM has morphology and smooth surface identical to those in Example 1.

### COMPARATIVE EXAMPLE 1

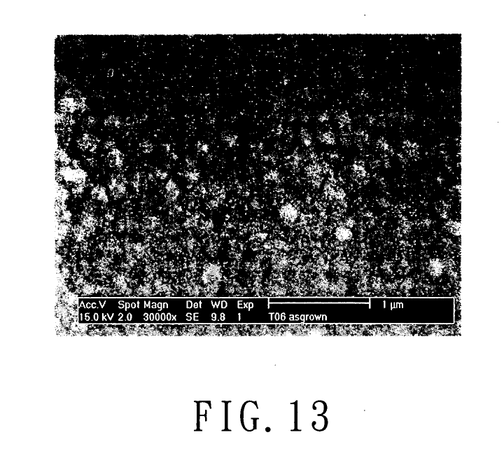

Comparative example 1 differs from Example 1 in that the amount of ammonium hexafluorotitanate employed is 20 g (0.1 mole). That is, B/Ti ratio is 1.5. During the washing step, no crystals were detached from the glass plate, which indicates that the crystalline layer has a good adhesion to the glass plate. The result measured by UV-Vis spectrometer is shown by curve (b) in FIG. 7. The transmittance of the crystalline layer produced by the comparative example 1 is 0.05 at 325 to 450 nm, which is much smaller than that of Example 1 (0.2), and which implies that the crystalline layer of this comparative example is not ammonium oxotrifluorotitanate. Moreover, as shown in FIG. 13, the morphology of the crystalline layer of this comparative example 1 is also different from that of the crystalline layer of ammonium oxotrifluorotitanate of the examples.

### COMPARATIVE EXAMPLE 2

Comparative example 2 differs from Example 1 in that the amount of ammonium hexafluorotitanate employed is 300 g (1.5 mole). That is, B/Ti ratio is 0.1. During the washing step, the crystals were easily detached from the glass plate and thus have a poor adhesion to the glass plate.

It is noted that the adhesion between the silicon-containing layer and the crystalline layer of ammonium oxotrifluorotitanate is superior over that between the DODMA film and the crystalline layer of ammonium oxotrifluorotitanate. Moreover, in the method of this invention, the range of the reactant ratio (0.15≦B/Ti <1.5) is greater than that in the prior art (1≦B/Ti<1.5), and the temperature for converting ammonium oxotrifluorotitanate crystalline layer on the silicon-containing substrate into particulate titanate dioxide (i.e., 300-400° C.) is lower than that for converting ammonium oxotrifluorotitanate crystalline layer on the DODMA film in the prior art (600° C.). Hence, the method for making titanate-containing material of this invention is easily conducted and controlled, and the ammonium oxotrifluorotitanate-containing material thus formed has good properties and can be easily converted into titanate dioxide-containing material, thereby avoiding the use of restrictive operating conditions and complicated processes for precipitation, filtration, centrifugation, and deposition of titanium dioxide.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A titanate-containing material comprising:
a silicon-containing layer; and
a crystalline layer of ammonium oxotrifluorotitanate formed on said silicon-containing layer.

2. The titanate-containing material of claim 1, wherein said silicon-containing layer is made from a material selected from the group consisting of: polysilicon, Si₃N₄, SiO₂, and combinations thereof.

3. The titanate-containing material of claim 1, wherein said silicon-containing layer is in the form of a glass substrate.

4. The titanate-containing material of claim 1, wherein said silicon-containing layer has a thickness greater than 1 μm.

5. The titanate-containing material of claim 1, wherein said crystalline layer has a thickness less than 10 μm.

6. A method for making a titanate-containing material, comprising:
immersing a silicon-containing substrate into an aqueous solution containing hexafluorotitanate radicals; and
reacting the hexafluorotitanate radicals with water so as to form a crystalline layer of an oxotrifluorotitanate compound on the silicon-containing substrate.

7. The method of claim 6, wherein the aqueous solution further contains boric acid and ammonium ions.

8. The method of claim 7, wherein the hexafluorotitanate radicals are obtained from ammonium hexafluorotitanate.

9. The method of claim 7, wherein the oxotrifluorotitanate compound is ammonium oxotrifluorotitanate.

10. The method of claim 8, wherein the molar ratio of ammonium hexafluorotitanate to boric acid is greater than 0.1 and less than 1.5.

11. A method for producing titanium dioxide particles, comprising the steps of:
forming a hexafluorotitanate compound on a silicon-containing substrate; and
calcining the hexafluorotitanate compound on the silicon-containing substrate.

12. The method of claim 11, wherein the calcining operation is conducted at a temperature ranging from 300 to 400° C.
